(19) United States
(12) Patent Application Publication
(10) Pub. No.: US 2022/0184699 A1
(43) Pub. Date: Jun. 16, 2022

(54) METHOD OF FABRICATING AN INTERFACIAL STRUCTURE AND A FABRICATED INTERFACIAL STRUCTURE

(71) Applicants: Nanyang Technological University, Singapore (SG); Agency For Science, Technology And Research, Singapore (SG)

(72) Inventors: Hock Lye John PANG, Singapore (SG); Zhi'En Eddie TAN, Singapore (SG); Jacek KAMINSKI, Singapore (SG)

(21) Appl. No.: 17/425,673

(22) PCT Filed: Feb. 11, 2020
(86) PCT No.: PCT/SG2020/050063

§ 371 Date: Jul. 23, 2021

(30) Foreign Application Priority Data
Feb. 11, 2019 (SG) 10201901130S

(51) Int. Cl. B22F 7/08; B33Y 80/00

(52) U.S. Cl. CPC B22F 7/08; B22F 10/28; B33Y 80/00

(57) ABSTRACT

A method of fabricating an interfacial structure, the interfacial structure comprising a substrate and a projection on the substrate, the method comprising the steps of:
a) providing the substrate;
b) creating a number of steps on a surface of the substrate; and
c) fabricating the projection on the substrate by additive manufacturing onto the number of steps, thereby creating a stepped interfacial joint between the substrate and the projection.

A fabricated interfacial structure comprising: a substrate having a number of steps created on a surface of the substrate; a projection fabricated by additive manufacturing onto the number of steps; and a stepped interfacial joint between the substrate and the projection.

This invention relates to a method of fabricating an interfacial structure and a fabricated interfacial structure.

### BACKGROUND

Various engineering applications require geometrical modifications to be made to components, including, but not limited to, flanges, ridges and other functional structures and features. The aerospace and automotive industries, in particular, have key applications that utilize fabricated interfacial structures comprising two interfacing metallic solid bodies, such as air-foils and exhaust manifolds. Such fabricated interfacial structures often comprise a substrate and a projection fabricated on the substrate, where the substrate could be a newly fabricated part or an existing part. In view of the known disadvantages of using fasteners and adhesives, in applications like remanufacturing and feature modification in the aerospace and automotive industries, laser metal deposition (LIVID) has instead been used to fabricate projections on substrates. However, this approach embodies intrinsic disadvantages as existing methods of fabricating interfacial structures using LIVID are generally weak at the interfacial location due to poor interfacial bonding between the substrate and the projection built by LIVID on the substrate. There is therefore a demand for a method of fabricating interfacial structures of two or more parts that avoids the disadvantages of poor interfacial strength associated with building or joining parts using existing LIVID techniques to fabricate projections on substrates.

### SUMMARY

According to a first aspect, there is provided a method of fabricating an interfacial structure, the interfacial structure comprising a substrate and a projection on the substrate, the method comprising the steps of:
a) providing the substrate;
b) creating a number of steps on a surface of the substrate; and
c) fabricating the projection on the substrate by additive manufacturing onto the number of steps, thereby creating a stepped interfacial joint between the substrate and the projection.

Step b) may comprise creating the number of steps as a recess on the surface of the substrate.

Step b) may comprise creating the number of steps to fully surround the recess.

Step b) may comprise creating the number of steps as a protrusion on the surface of the substrate.

Step b) may comprise creating the number of steps to fully surround the projection.

Step b) may comprise creating the number of steps by subtractive manufacturing.

In step b), the number of steps may be created by metal machining and in step c), the projection may be created by laser metal deposition.

Step a) may comprise fabricating the substrate by additive manufacturing.

Step b) may comprise creating the number of steps during additive manufacturing fabrication of the substrate.

Step a) may comprise creating a fillet between at least one upwards-facing surface and one sideways-facing surface.

Step a) may comprise creating a chamfer between at least one sideways-facing surface and one upwards-facing surface.

Step b) may comprise fabricating a thin-walled solid body of the projection onto the number of steps.

Step b) may comprise fabricating a non-hollow portion of the projection onto the number of steps.

According to a second aspect, there is provided a fabricated interfacial structure comprising: a substrate having a number of steps created on a surface of the substrate; a projection fabricated by additive manufacturing onto the number of steps; and a stepped interfacial joint between the substrate and the projection.

The number of steps may be created as a recess on the surface of the substrate.

The number of steps may fully surround the recess.

The number of steps may be created as a protrusion on the surface of the substrate.

The number of steps may fully surround the protrusion.

The projection may comprise a thin-walled solid body fabricated onto the number of steps.

The projection may comprise a non-hollow solid body fabricated onto the number of steps.

For both aspects, the stepped interfacial joint may comprise a metallurgical bond.

Each of the number of steps may comprise a sideways-facing surface and an upwards-facing surface when the surface of the substrate may be facing up, each sideways-facing surface may be at an angle θ from the vertical and each upwards-facing surface may be at an angle α from the horizontal, and θ and α each may range from 0° to 80°.

### BRIEF DESCRIPTION OF FIGURES

In order that the invention may be fully understood and readily put into practical effect there shall now be described by way of non-limitative example only exemplary embodiments of the present invention, the description being with reference to the accompanying illustrative drawings.

FIG. 1 is a schematic cross-sectional view of a stepped interfacial joint between a non-hollow solid body substrate and a non-hollow solid body projection.

FIG. 2(a) is a perspective view of a stepped fabricated interfacial structure comprising a cuboid non-hollow solid body projection fabricated by additive manufacturing on a plurality of steps created as a recess on a surface of a substrate.

FIG. 2(b) is a perspective view of a stepped fabricated interfacial structure comprising a cylindrical non-hollow solid body projection fabricated by additive manufacturing on a plurality of steps created as a recess on a surface of a substrate.

FIG. 3 is a perspective view of a stepped fabricated interfacial structure comprising an air-foil non-hollow solid body projection fabricated by additive manufacturing on a plurality of steps created as a recess on a surface of a substrate.

FIG. 4(a) is a schematic cross-sectional view of a symmetrical stepped interfacial joint between a non-hollow solid body substrate and a thin-walled solid body projection.

FIG. 4(b) is a schematic cross-sectional view of an asymmetrical stepped interfacial joint between a non-hollow solid body substrate and a thin-walled solid body projection.

FIG. 5(a) is a perspective view of a stepped fabricated interfacial structure comprising a cuboid thin-walled solid body projection fabricated by additive manufacturing on a plurality of steps created as a recess on a surface of a substrate.

FIG. 5(b) is a perspective view of a stepped fabricated interfacial structure comprising a cylindrical thin-walled solid body projection fabricated by additive manufacturing on a plurality of steps created as a recess on a surface of a substrate.

FIG. 6 is a perspective view of a stepped fabricated interfacial structure comprising an exhaust manifold thin-walled solid body projection fabricated by additive manufacturing on a plurality of steps created as a recess on a surface of a substrate.

FIG. 7(a) is a schematic cross-sectional view of a chamfered stepped interfacial structure comprising a projection fabricated by additive manufacturing on a plurality of chamfered steps created as a recess on a surface of a substrate.

FIG. 7(b) is a schematic cross-sectional view of a chamfered stepped interfacial structure comprising a projection fabricated by additive manufacturing on a plurality of chamfered steps created as a protrusion on a surface of a substrate.

FIG. 8(a) is a schematic cross-sectional view of a filleted stepped interfacial structure comprising a projection fabricated by additive manufacturing on a plurality of filleted steps created as a recess on a surface of a substrate.

FIG. 8(b) is a schematic cross-sectional view of a filleted stepped interfacial structure comprising a projection fabricated by additive manufacturing on a plurality of filleted steps created as a protrusion on a surface of a substrate.

FIG. 9(a) is a perspective view of a portion of a spur gear.

FIG. 9(b) is a perspective view of the portion of the spur gear having a damaged gear tooth.

FIG. 9(c) is a perspective view of the portion of the spur gear having a number of steps created as a recess on the surface of the spur gear at the damage site.

FIG. 9(d) is a perspective view of a portion of the repaired spur gear comprising a gear tooth projection fabricated by additive manufacturing on the number of steps created in the recess on the surface of the spur gear.

FIG. 10 is a flow chart of a fabrication and test sequence of an investigation into the mechanical performance of three different interfacial structures.

FIG. 11(a) shows isometric, 11(b) front and 11(c) side views with dimensions of a substrate in a flat interfacial structure.

FIG. 12(a) shows isometric, 12(b) front and 12(c) side views with dimensions of a substrate in a V-shaped interfacial structure.

FIG. 13(a) shows isometric, 13(b) front and 13(c) side views with dimensions of a substrate in a stepped interfacial structure.

FIG. 14(a) shows front and 14(b) isometric views of a flat interfacial structure comprising a projection fabricated by laser material deposition (LIVID) on the substrate of FIGS. 11(a)-(c).

FIG. 15(a) shows front and 15(b) isometric views of a V-shaped interfacial structure comprising a projection fabricated by LIVID on the substrate of FIGS. 12(a)-(c).

FIG. 16(a) shows front and 16(b) isometric views of a stepped interfacial structure comprising a projection created by LIVID on the substrate of FIGS. 13(a)-(c).

FIG. 17 is a schematic illustration of a deposition sequence in the LIVID process.

FIG. 18 is a side view illustration with dimensions of Charpy test samples extracted from an interfacial structure comprising a substrate and a projection created by LIVID on the substrate.

FIG. 19(a) is an isometric view of a Charpy test sample of a flat interfacial structure.

FIG. 19(b) is an isometric view of a Charpy test sample of a V-shaped interfacial structure.

FIG. 19(c) is an isometric view of a Charpy test sample of a stepped interfacial structure.

FIG. 19(d) is an isometric view of a Charpy test sample of a flat interfacial structure having a rotated notch relative to the Charpy test sample of FIG. 19(a).

FIG. 19(e) is an isometric view of a Charpy test sample of a V-shaped interfacial structure having a rotated notch relative to the Charpy test sample of FIG. 19(b).

FIG. 19(f) is an isometric view of a Charpy test sample of a stepped interfacial structure having a rotated notch relative to the Charpy test sample of FIG. 19(c).

FIG. 20(a) is a photograph of a Zwick Roell, Amsler RKP 450 Charpy test machine comprising a 300 J pendulum head.

FIG. 20(b) is a photograph of a Charpy test sample mounted in the Charpy test machine of FIG. 3 20(a).

FIG. 21(a) is a post-test photograph of Charpy test samples of the configuration of FIG. 19(a).

FIG. 21(b) is a post-test photograph of Charpy test samples of the configuration of FIG. 19(b).

FIG. 21(c) is a post-test photograph of Charpy test samples of the configuration of FIG. 19(c).

FIG. 21(d) is a post-test photograph of Charpy test samples of the configuration of FIG. 19(d).

FIG. 21(e) is a post-test photograph of Charpy test samples of the configuration of FIG. 19(e).

FIG. 21(f) is a post-test photograph of Charpy test samples of the configuration of FIG. 19(f).

FIG. 22(a) is a graph of Charpy test results for Charpy test samples of the configurations of FIGS. 19(a) to 19(c).

FIG. 22(b) is a graph of Charpy test results for Charpy test samples of the configurations of FIGS. 19(d) to 19(f).

FIG. 23 shows main effects plots of toughness of the different Charpy test samples for the different interfacial structures and notch orientations.

FIG. 24(a) shows fracture surface topology for Charpy test samples of the configuration of FIG. 19(a).

FIG. 24(b) shows fracture surface topology for Charpy test samples of the configuration of FIG. 19(b).

FIG. 24(c) shows fracture surface topology for Charpy test samples of the configuration of FIG. 19(c).

FIG. 24(d) shows fracture surface topology for Charpy test samples of the configuration of FIG. 19(d).

FIG. 24(e) shows fracture surface topology for Charpy test samples of the configuration of FIG. 19(e).

FIG. 24(f) shows fracture surface topology for Charpy test samples of the configuration of FIG. 19(f).

FIG. 25 is a flow chart of an exemplary method of fabricating an interfacial structure.

### DETAILED DESCRIPTION

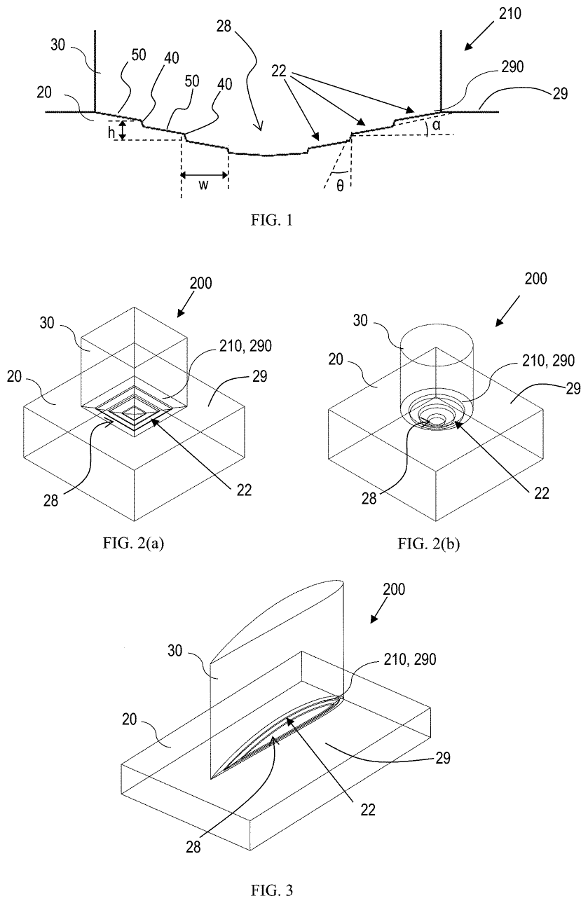

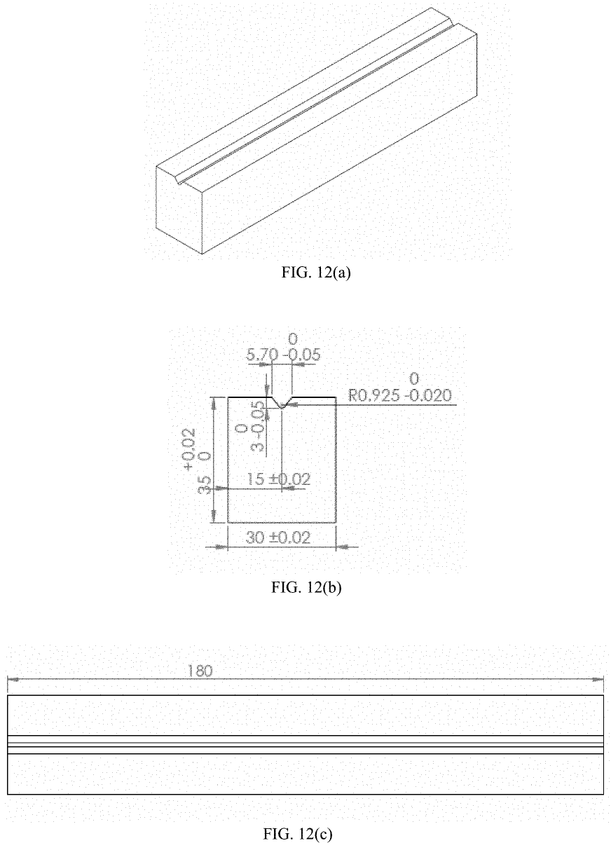

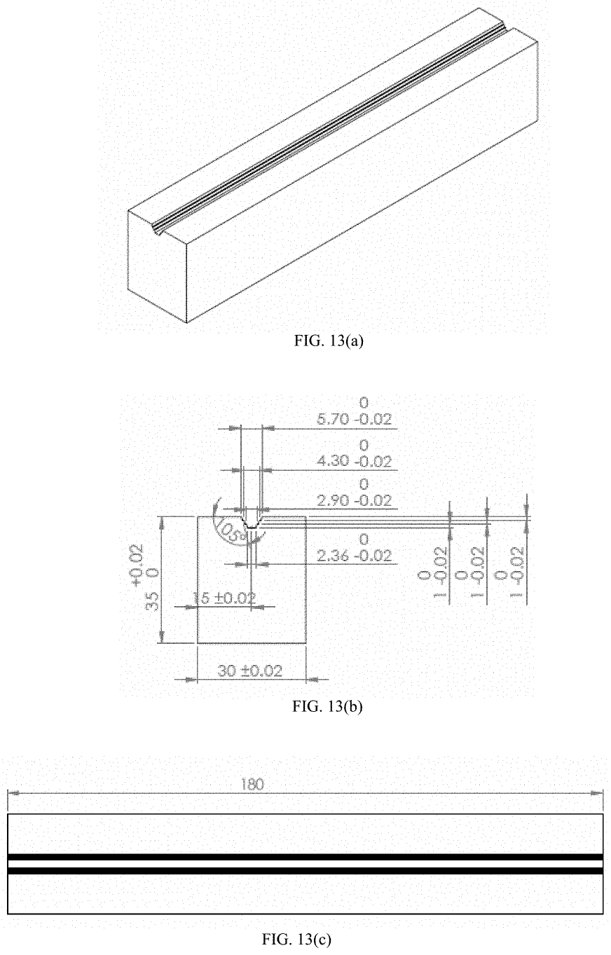

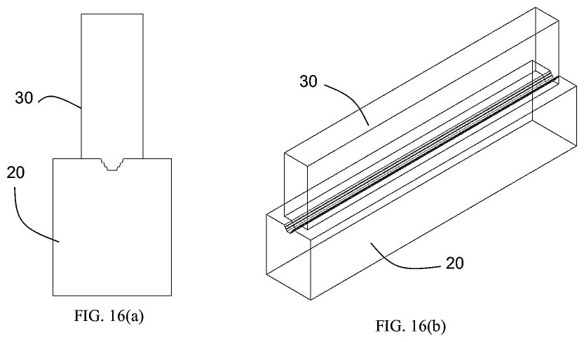

Exemplary embodiments of a method 100 of fabricating an interfacial structure 200 and the fabricated interfacial structure 200 will be described below with reference to FIGS. 1 to 25. The same reference numerals are used across the figures to refer to the same or similar parts.

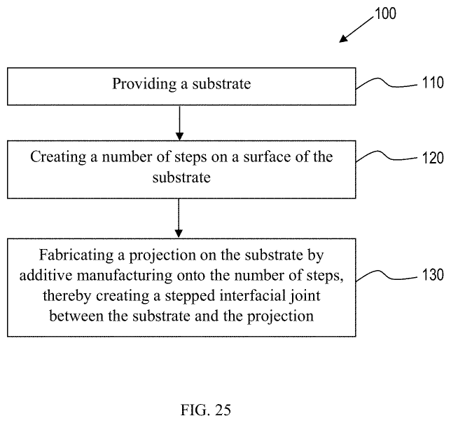

As shown in FIGS. 1 and 25, in the method 100 of fabricating an interfacial structure 200, a substrate 20 is provided (110) as a recipient for a projection 30 that is to be fabricated on the substrate 20. The projection 30 is fabricated by additive manufacturing on the substrate 20 (130) and extends outwardly from a surface 29 of the substrate 20. Throughout the present specification, the projection 30 may interchangeably be referred to as an interfacial projection 30 as the projection 30 interfaces with the substrate 20 at an interface 290 to form an interfacial joint 210. The interfacial joint 210 may interchangeably referred to as an interfacial build/joint 210 since the projection 30 is simultaneously built up and joined to the substrate 20 by additive manufacturing on the substrate 20 at the interfacial joint 210. The term “substrate” is used throughout the present specification to refer to any type of part that the projection 30 is fabricated on. For example, the substrate 20 may be a newly fabricated part made by any known method including but not limited to additive manufacturing, or the substrate 20 may be an existing part including but not limited to an existing part having a damage site to be remanufactured.

In the method 100, the substrate 20 is provided (110) and a number of steps 22 are created on the surface 29 of the substrate 20 (120) using any known method such as metal machining, mechanical fabricating, laser treatment or even during additive manufacturing fabrication of the substrate 20. In an exemplary embodiment, the substrate 20 may be fabricated by additive manufacturing while the number of steps 22 are created by metal machining on the fabricated substrate 20. The number of steps 22 created may range from two to several hundred, depending on the application's requirements and implementation form. As can be seen in all the figures, each of the number of steps 22 comprises a sideways-facing surface 40 and an upwards-facing surface 50 when the surface 29 of the substrate 20 is facing up. The distance between adjacent sideways-facing surfaces 40 defines a width w of each step 22 and the distance between adjacent upwards-facing surfaces 50 defines a height h of each step 22, as depicted in in FIGS. 1, 4 and 7. A combination of different h and w values can be used within a single instance of a stepped joint 210 implementation. For example, one of the number of steps 22 can have a particular step height h value while another of the number of steps 22 within a same stepped interface 290 implementation can have a differing h value. These differing h values can be denoted as h−1, h−2, and so on. Similarly, one of the number of steps 22 can have a particular step width w value while another of the number of steps 22 within a same stepped interface 290 implementation can have a differing w value. These differing w values can be denoted as w−1, w−2, and so on.

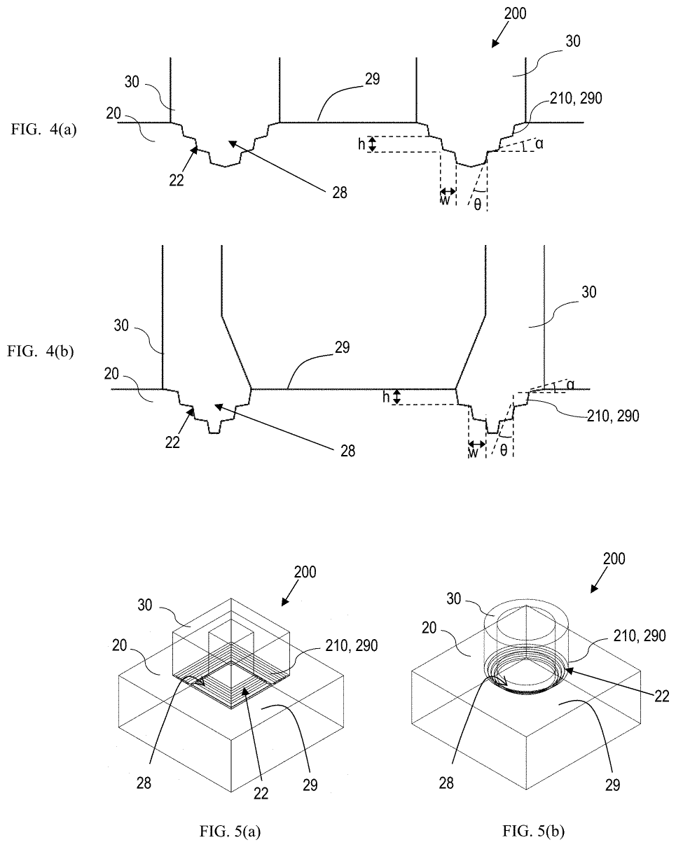

As indicated in FIGS. 1 and 4, the step height h at the interface 290 may be optimized by adjusting h to a value ranging between 0.1 mm and 5 mm, depending on the application's requirements and implementation form. Similarly, the step width w at the interface 290 may be optimized by adjusting w to a value ranging between 1 mm and 300 mm, depending on the application's requirements and implementation form. The step width w is preferably directly related to the step height h and the actual number of steps 22 created on the substrate 20.

Each sideways-facing surface 40 of the number of steps 22 is created at an angle θ from the vertical (referred to as the vertical step angle θ) and each upwards-facing surface of the number of steps 22 is created at an angle α from the horizontal (referred to as the horizontal step angle α), as also depicted in in FIGS. 1, 4 and 7. The vertical step angle θ at the interface 290 may be optimized by adjusting it to an angle between 0° and 80°. Similarly, the horizontal step angle α at the interface 290 may be optimized by adjusting it to an angle ranging between 0° and 80°. Both angle selections are dependent on the application's requirements and implementation form. A combination of different “α” and “θ” values can be used within a single instance of stepped joint implementation. For example, one of the number of steps 22 can have a particular α value while another of the number of steps 22 within the same stepped interface implementation can have a differing α value. These α values can be denoted as α-1, α-2, and so on. Similarly, one of the number of steps 22 can have a particular θ value, and another of the number of steps 22 within the same stepped interface implementation can have a differing θ value. These θ values can be denoted as θ-1, θ-2, and so on.

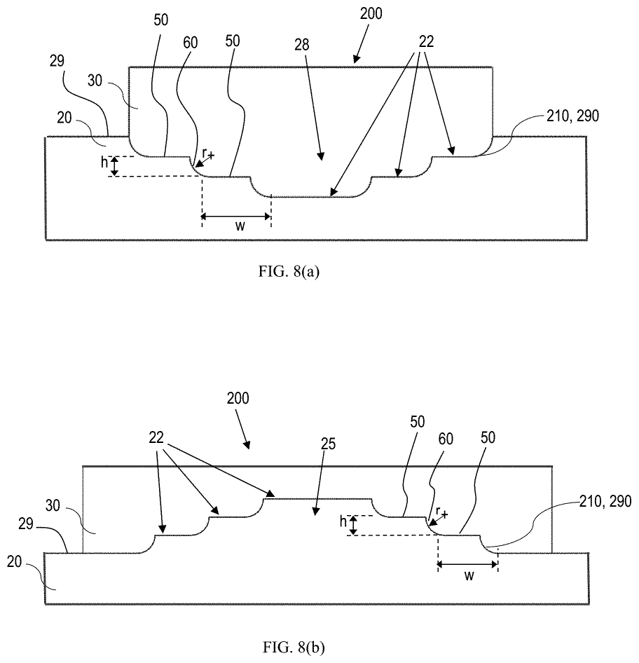

Furthermore, the number of steps 22 may have a chamfered configuration as shown in FIG. 7, or a filleted configuration in FIG. 8 where a fillet 60 of radius r is created between adjacent upwards-facing surface 50. As indicated in FIG. 8, in the case where a filleted stepped joint 210 design is picked over a chamfered stepped joint 210 design, the fillet radius r can be optimized by adjusting it to a value ranging between 0.5 mm and 5 mm. The fillet interfacial build/joint design is defined based on h, and r. As indicated in FIGS. 7 and 8, stepped interfacial build/joint variants in the form of a concave or convex, as well as a chamfer or fillet substrate interface design can be selected based on the geometrical accessibility and availability at the substrate preparation stage of the manufacturing process.

After creating the number of steps 22 on the substrate 20 (120), the projection 30 is then fabricated on the substrate 20 by additive manufacturing onto the number of steps 22 (130) such that a stepped interfacial joint 210 is created between the projection 30 and the substrate 20. Fabricating the projection 30 comprises building up the projection 30 layer by layer using additive manufacturing that directly deposits material of the projection 30 on the number of steps 22 on the substrate 20. The substrate 20 and the projection 30 may be made of metal so that the projection 30 is joined to the substrate 20 by a stepped interfacial build/joint 210 that comprises a metallurgical bond, for example, when the additive manufacturing comprises metallic direct energy deposition (DED) such as laser metal deposition (LMD).

The resulting fabricated interfacial structure 200 thus comprises an interfacial build/joint 210 having a stepped joint interface 290 between the substrate 20 and the projection 30. By employing an interfacial projection 30 design in the form of a stepped joint interface 290, an improved interfacial bond between the substrate 20 and the projection 30 is achieved. A stepped interface 290 spreads an acting load over a larger area at the stepped interfacial joint 210, hence strengthening it.

Exemplary embodiments of interfacial structures 200 fabricated using the method 100 can be seen in FIGS. 2, 3, 7(a) and 8(a) where the projection 30 comprises a non-hollow solid body and the number of steps 22 are created as a recess 28 on the surface 29 of the substrate 20. For example, the interfacial projection 30 may have a cuboid, cylindrical or air-foil configuration as shown in FIGS. 2(a), 2(b) and 3 respectively, and the stepped interface 290 may have a chamfered or filleted configuration as shown in FIGS. 7(a) and 8(a).

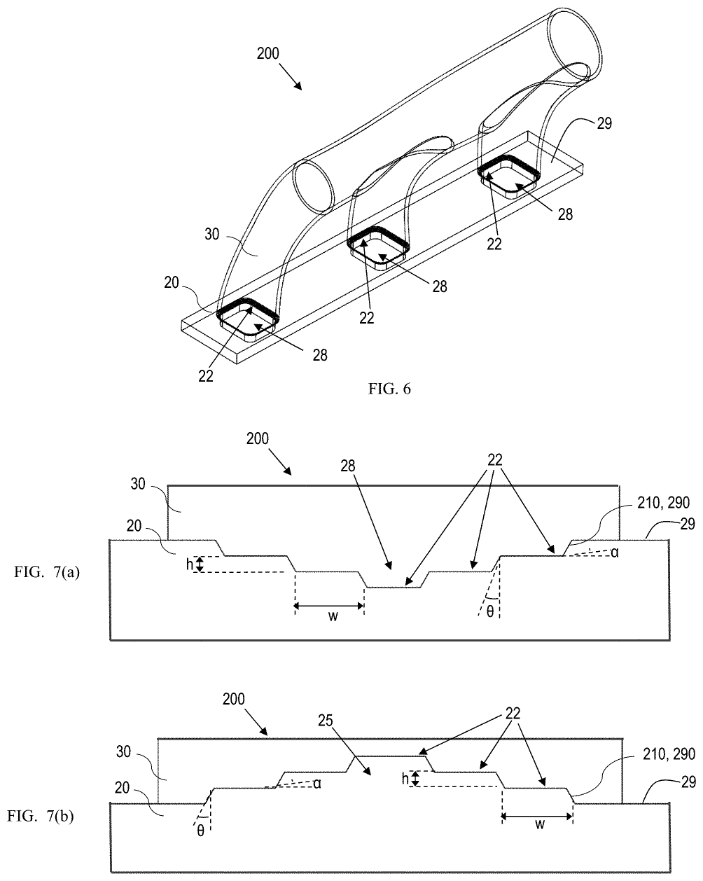

FIGS. 4 and 5 show alternative embodiments of interfacial structures 200 fabricated where the projection 30 comprises a thin-walled solid body and the number of steps 22 are created as an annular recess 28 on the surface 29 of the substrate 20. By “thin-walled solid body”, this is meant that the solid body has an at least partially tubular configuration where a central portion of the solid body projection 30 is hollow, as can be seen in FIGS. 4 and 5. The stepped joint interface 290 may have a symmetrical cross-sectional profile as shown in FIG. 4(a) or it may have an asymmetrical cross-sectional profile with an extended trench configuration as shown in FIG. 4(b). For example, the interfacial projection 30 may have a cuboid or cylindrical thin-walled solid body configuration and the stepped recess 28 created in the substrate 20 may correspondingly comprise a rectangular annular recess 28 or circular annular recess 28 respectively as shown in FIGS. 5(a), and 5(b). FIG. 6 shows another embodiment of a fabricated interfacial structure 200 comprising a thin-walled solid body projection 30 having an exhaust manifold configuration that is fabricated by additive manufacturing onto multiple recesses 28 each comprising a single step 22 on the surface 29 of the substrate 20.

While the projection 30 has been depicted as comprising either a fully non-hollow solid body or a fully thin-walled solid body as shown in FIGS. 2 to 8, it should be noted that the interfacial projection design can also be extended to various other free-form geometries as may be desired.

As an alternative to the number of steps 22 being created as a recess 28 on the surface 29 of the substrate 20, the number of steps 22 may instead be created as a protrusion 25 on the surface 29 of the substrate 20, as shown in FIGS. 7(b) and 8(b).

The strength of the interfacial build/joint 210 where the projection 30 interfaces and joins the substrate 20 is proportional to the net interfacial area of the joint interface 290. Prior art interfacial joints typically have a flat joint interface between two joined bodies that result in a smaller interfacial area than a stepped interfacial build/joint design. Advantageously, a stepped interfacial build/joint 210 would use various step design parameters such as h, w, r, θ and α as described above to define its design, as indicated in FIGS. 1, 4, 7 and 8. These step design parameters maximize the net interfacial build/joint area of the joint interface 290.

For a cuboid interfacial build/joint design as shown in FIG. 2 (a), the conventional (prior art) manifestation of an interfacial build/joint feature would be a flat interface area where Area=Length×Breadth. Likewise, for a thin-walled cuboid interfacial build/joint design as shown in FIG. 5 (a), the conventional (prior art) manifestation of an interfacial build/joint feature would be a flat interface area where Area=(Outer Length×Outer Breadth)−(Inner Length×Inner Breadth). For a cylindrical interfacial build/joint design as shown in FIG. 2 (b), the conventional (prior art) manifestation of an interfacial build/joint feature would be a flat interface area where “Area=π×radius²”. Likewise, for a thin-walled cuboid interfacial build/joint design as shown in FIG. 5 (b), the conventional (prior art) manifestation of an interfacial build/joint feature would be a flat interface area where “Area=(π×Outer radius²)−(π×Inner radius²)”. For free-form interfacial joint designs as shown in FIGS. 3 and 6, the conventional (prior art) manifestation would also be that of a flat interface area.

In contrast with the above-described conventional (prior art) manifestations of interfacial build/joint designs that typically have a flat interface area, in the present application, by introducing stepped features comprising a number of steps 22 at the build/joint interface 290, the above-defined parameters of h, w, r, α, θ and number of steps 22 as shown in FIGS. 1, 4, 7 and 8 can be adjusted and optimized to increase the interfacial build/joint area significantly.

Induced stresses on the joint interface 290 is such that “Stress=Force÷Area”. Hence, the strength of any interface is proportional to its respective interfacial area. By introducing stepped features in the form of a number of steps created on the substrate 20 and thereby increasing the interfacial area, the interfacial build/joint 210 can be strengthened significantly by spreading any acting load over a larger area. Joint strength properties such as 3D stresses against tensile, shear, bending stresses, and impact strength can thus be strengthened.

For instance, for a cuboid interfacial build/joint feature with dimensions “L×B=50 mm×50 mm”, the conventional (prior art) flat interfacial build/joint has a net interfacial area of 2500 mm². By comparison, the same cuboid interfacial build/joint feature with an added stepped build/joint interface 290 comprising five steps 22 where α=0°, θ=0°, w=5 mm and h=3 mm for each step, the net interfacial area is 4300 mm². Since any acting load on the interfacial build/joint feature is spread over a larger interfacial build/joint area for a similar interfacial build/joint feature with a stepped interfacial build/joint design, the interfacial strength can hence be improved proportionally by 1.5 to 2 times.

Exemplary Application—Repair of Damaged Spur Gear

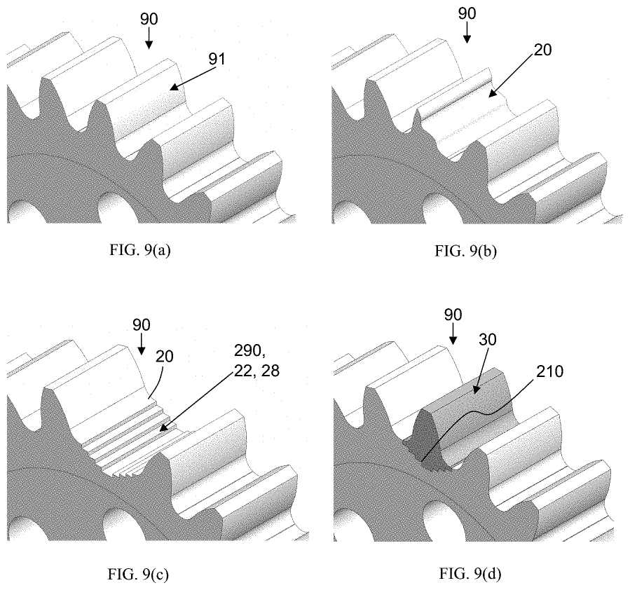

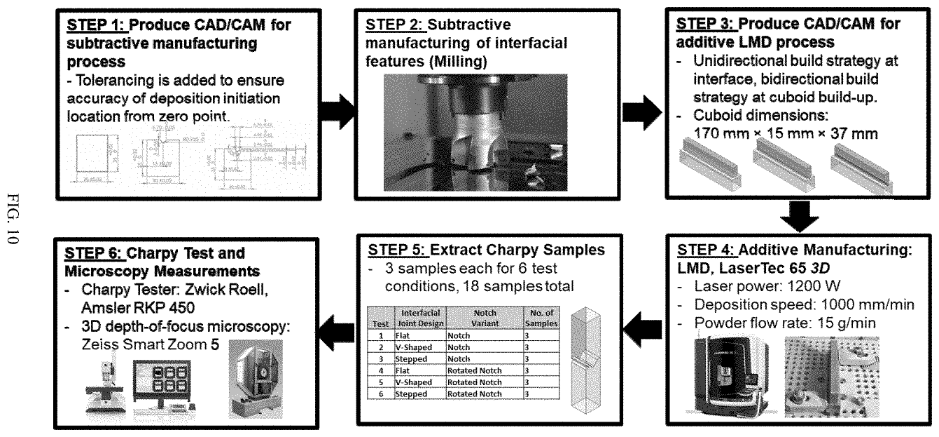

In an exemplary application of the present invention, a spur gear 90 (FIG. 9(a)) having a gear tooth 91 that has been chipped off may be remanufactured using the above described method 100. The damage site 20 of the gear 90 (FIG. 9(b)) where the chipped off gear tooth 91 used to be located may be considered the substrate 20 on which a stepped recess 22, 28 is created using subtractive manufacturing, as shown in FIG. 9(c), to create a stepped recess 22, 28 on the gear 90 at the damage site 20. A remanufactured “new” gear tooth 30 may then be fabricated as the projection 30 by additive manufacturing on the stepped recess 22, 28 on the damage site 20, so that the new tooth 30 is joined to the gear 20 via a stepped interfacial joint 210 that comprises a metallurgical bond. To do so, the damage site 20 is first inspected for its degree of wear and damage, as well as any other form of defects, like cracks or plastic deformation. Non-destructive inspection techniques like ultrasonic measurements can be used to detect any cracks that have propagated from the initial chipped area. After diagnosing the degree of damage, a suitable stepped joint interface 290 that in this example comprises a stepped recess 22, 28 is devised to ensure that the subtractive process removes any defects within the damage site 20. The stepped interface 290 is created in computer aided drawing (CAD) and computer aided manufacturing (CAM) software and produced using subtractive manufacturing techniques on the damage site 20 with a hybrid machine, for example a milling machine, as seen in FIG. 9(c). The gear tooth 30 to be built up from the interfacial joint feature 210 is created in CAD and CAM software and is additively manufactured using LIVID from the same hybrid machine, as can be seen in FIG. 9 (d). Lastly, subtractive manufacturing may be used to produce the surface finishing required of the restored gear tooth 30.

Investigation into the Mechanical Performance of Three Different Interfacial Structures

A study was conducted to investigate the mechanical performance of three different interfacial joints: flat interfacial joint (prior art), v-shaped interfacial joint (prior art), and stepped interfacial joint 210 (present disclosure). The flat interfacial joint design is the conventional interfacial design for additively manufactured fabricated interfacial structures. The v-shaped interfacial joint design and the stepped interfacial joint 210 design are two variants whose mechanical performance are compared to the conventional flat interfacial joint design in this study. The sample fabrication and test sequence are shown in FIG. 10.

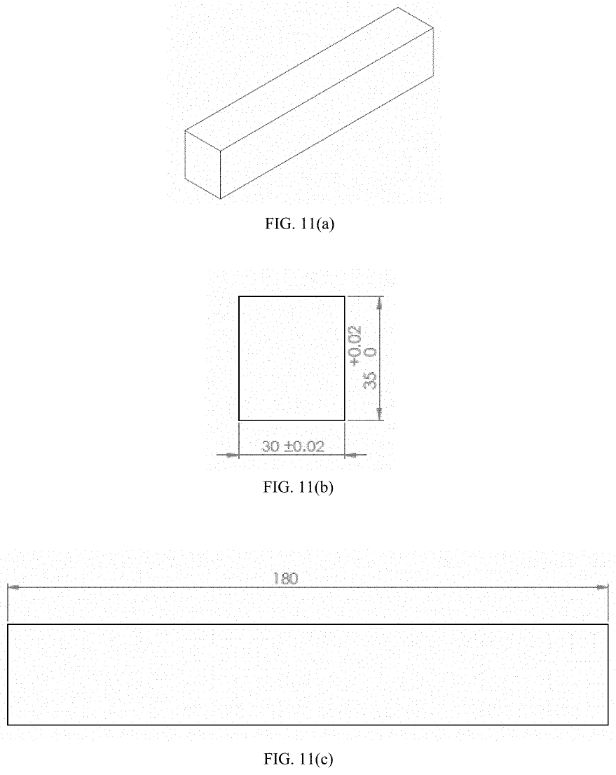

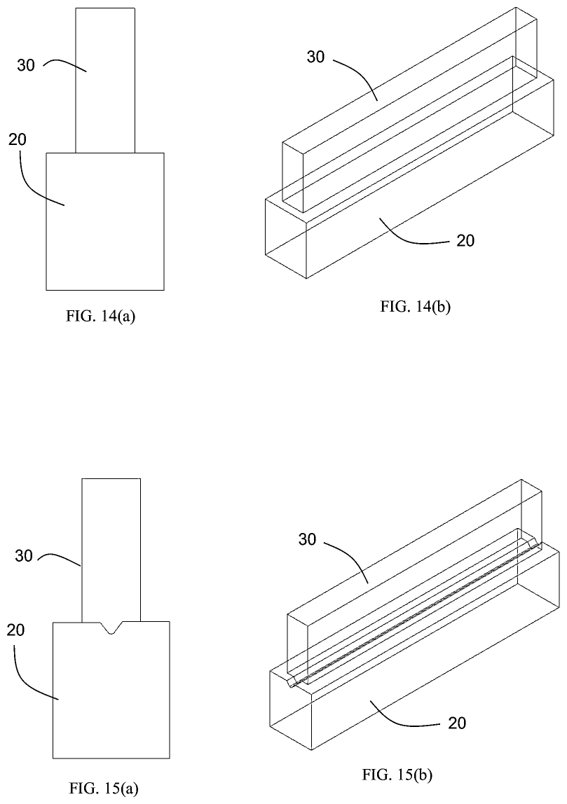

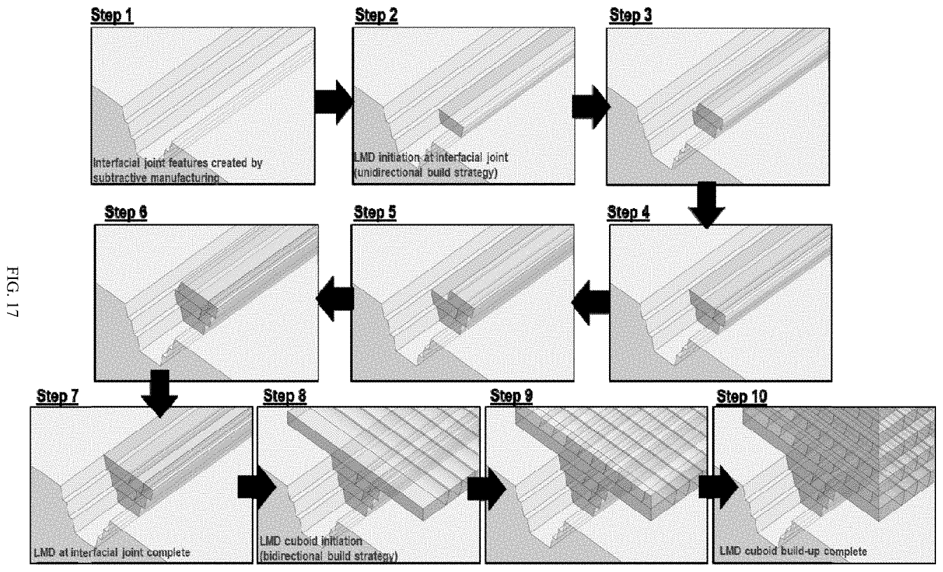

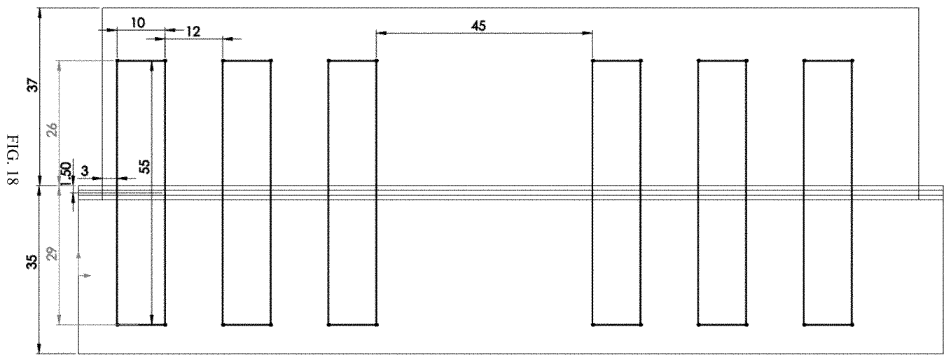

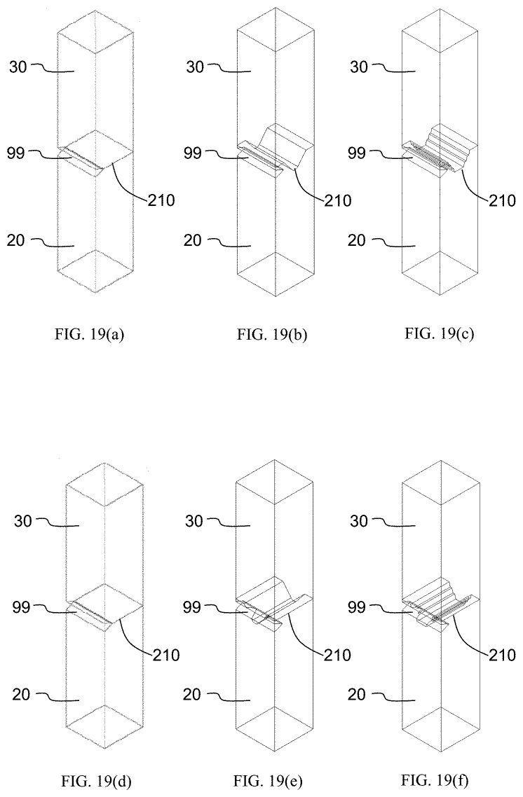

In the experiments conducted, a projection 30 comprising a Stainless Steel 316L cuboid of 170 mm×15 mm×37 mm was built by LIVID over a Stainless Steel 316L substrate 20 designed with each interfacial joint type being studied. The substrate 20 design and dimensions for the three different interfacial joints 210: flat interfacial joint (prior art), v-shaped interfacial joint (prior art), and stepped interfacial joint (present disclosure) are detailed in FIGS. 11, 12 and 13 respectively. The projection 30 built up by LIVID over the substrate 20 for each interfacial joint type is illustrated in FIGS. 14, 15 and 16. The deposition sequence of the LIVID to form the projection 30 is illustrated in FIG. 17. Dimensions of the projection 30 fabricated by LIVID were selected based on the build volume required to extract six Charpy samples, where the notch is located at the middle of the interfacial structure 200. An illustration of the Charpy sample extraction locations from an interfacial structure 200 comprising the substrate 20 and projection 30 fabricated by LIVID on the substrate 20 is shown in FIG. 18. For each of the Charpy samples obtained, half of its volume was in the LIVID projection 30 region, and the other half was in the substrate 20 region, as shown in FIG. 19. Two variants for the Charpy sample for each type of interfacial joint 210 was used. The two variants differed in where the notch 99 is located for each Charpy sample type. The Charpy sample for each interfacial joint design type and the location of the notch 99 for each Charpy notch variant are shown in FIGS. 19(a)-(f). Three Charpy samples were extracted and tested for each notch variant type. The objective of using two notch variants is to investigate the effects of the directionality of the impact on the mechanical performance of the interfacial joint 210.

The fracture surface topology of the Charpy samples were measured using a Zeiss Smart Zoom 5 with the 3D depth-of-focus microscopy method.

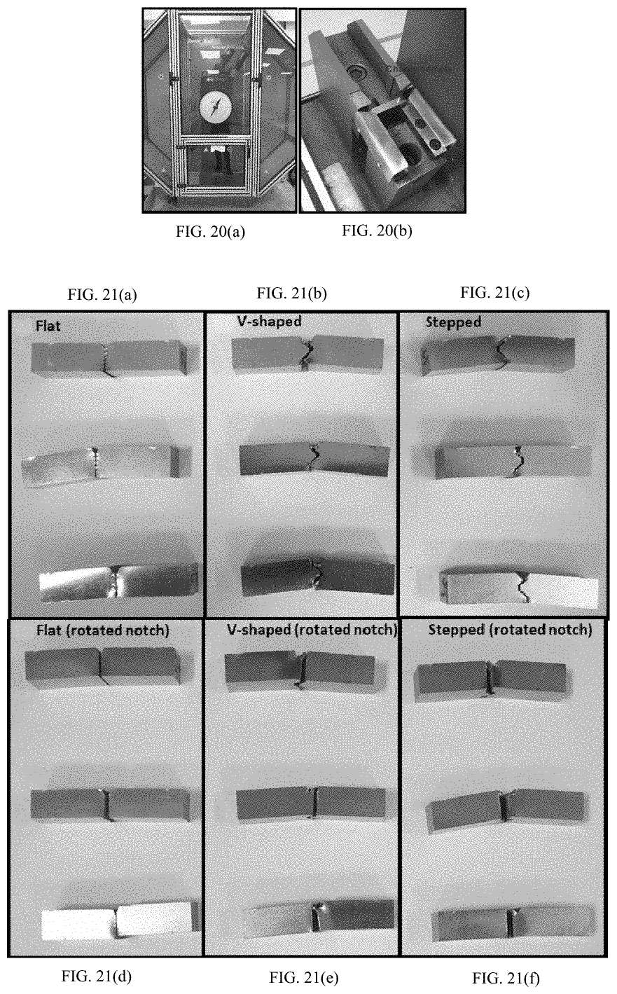

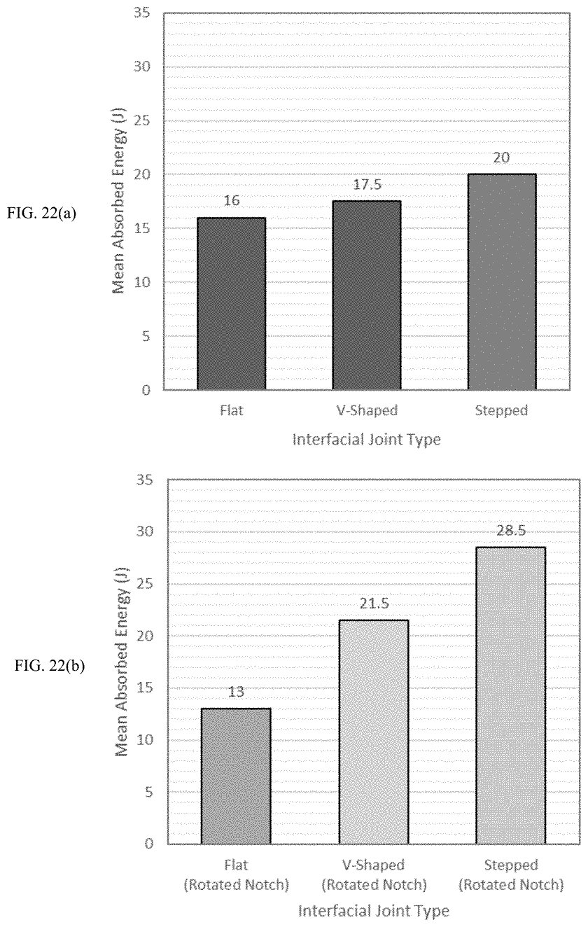

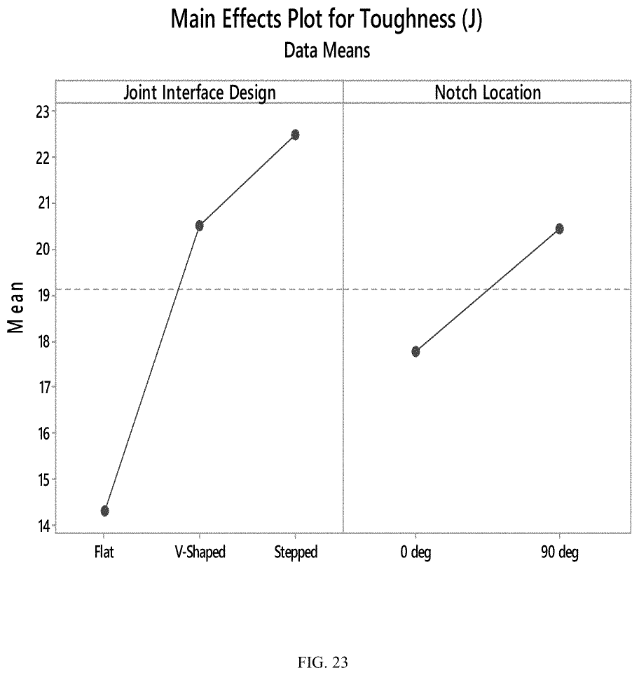

Charpy tests were conducted using a Zwick Roell, Amsler RKP 450 equipped with a 300 J pendulum hammer. Images of the Charpy tester and the Charpy sample mounting is shown in FIGS. 20 (a) and 20(b) respectively. Photographs of the post-test Charpy samples are shown in FIG. 21. Results for the Charpy test are shown in FIG. 22, and main effects plot for the different interfacial joints and notch variants are shown in FIG. 23. The V-shaped and stepped interfacial joint 210 designs produced a 9% to 119% improvement in toughness compared to the conventional flat interfacial joint design. The stepped joint interface 210 with a rotated notch produced the greatest improvement in toughness. This indicates that the stepped interfacial joint 210 created using the presently disclosed method 100 has a stronger mechanical performance in one direction over the other.

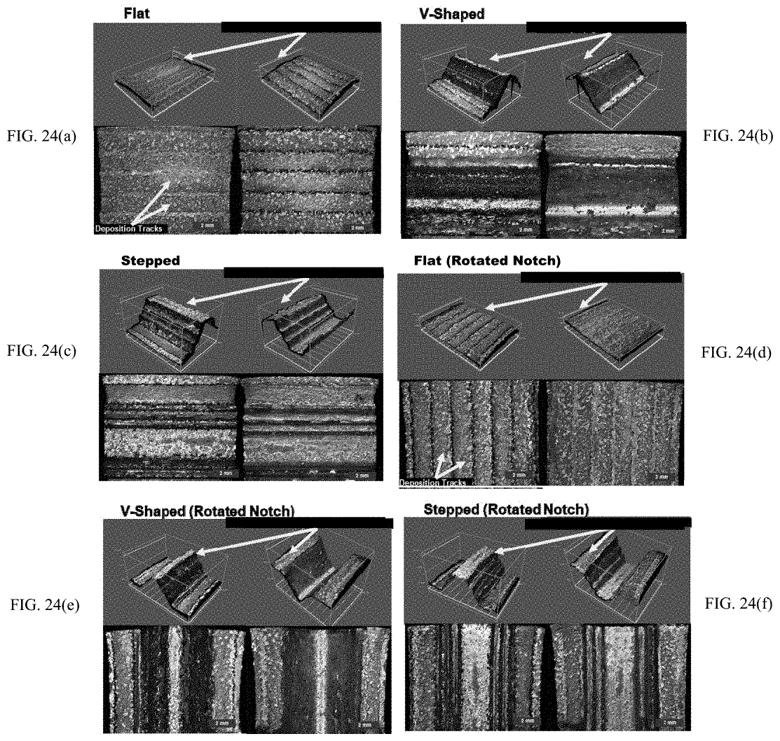

The main effects plot from FIG. 22 show that both the interfacial joint type and the directionality of the impact (as determined from the different notch variants) play an important role in the mechanical performance of the joint. Fracture surface topology images of the Charpy samples as shown in FIG. 24 were taken using a Zeiss Smart Zoom 5 using a 3D depth of focus reconstruction method, with 34 times magnification, 30 μm Z-axis resolution. The fracture surface topology microscopy images show that the crack propagation occurs along the joint interface as indicated by the two white arrows in each figure, a contributing factor to the difference in mechanical performance for each interfacial joint design type.

Using the above described method 100, no fasteners or adhesives are needed to join the projection 30 to the substrate 20 as the projection 30 and the substrate 20 are joined by a stepped interfacial joint 210 comprising a metallurgical bond arising from the use of additive manufacturing to fabricate the projection 30 on the number of steps 22 created on the substrate 20. The present method 100 also addresses the problem of poor bonding found at conventional flat interfacial joints that arise from fabricating projections on substrates using current LIVID methods. Unlike current LIVID methods that build on flat or grooved substrates the presently disclosed method introduces stepped interfacial features that provide a mechanically stronger joint than the conventional flat interfacial joint. The stepped interfacial joint 210 thus created is shown through the experiments described above to have superior toughness over conventional flat interfacial joints as well as V-shaped interfacial joints. The disclosed method 100 and resulting stepped interfacial joint 210 therefore avoid the problems of conventional fastener and adhesive joints and also provide superior joint toughness over existing flat interfacial joints, making them particularly suitable for aerospace and automotive applications to build and repair metal engine structures such as air-foils and exhaust manifolds, for example.

In an exemplary embodiment, by combining subtractive manufacturing in creating the number of steps on the substrate (120) with additive manufacturing in fabricating the projection 30 on the number of steps on the substrate (130), the presently disclosed method 100 allows structures with complex transition geometries at joint interfaces to be fabricated with mechanical interlocking interfaces that are metallurgically bonded. This allows for structures with unique geometries to be fabricated, thereby enabling development of products and parts that were once too costly to fabricate or could not feasibly be fabricated at all. The subtractive and additive manufacturing steps may even be combined in a single machine in hybrid manufacturing which is an emergent technology within the additive manufacturing sphere that aims to streamline and simplify the additive manufacturing process into conventional subtractive manufacturing lines. In this way, the incorporation of additive manufacturing into a manufacturing line is greatly simplified and hybrid manufacturing can be used to create the stepped interfacial features as disclosed in the present application, where subtractive manufacturing is first used to create the interfacial steps prior to using additive manufacturing to build up the intended feature as a projection. In a hybrid manufacturing implementation of the present method, additive manufacturing may even be initially used to fabricate the substrate prior to using subtractive manufacturing to create the number of steps on the surface of the substrate and followed by fabricating the projection by additive manufacturing on the number of steps. In this way, inherent weakness in the single-layer joint between the projection and the substrate of a structure that is fabricated entirely by additive manufacturing alone is avoided as the present method creates a stepped interface between the substrate and the projection, thereby increasing bonding area and accordingly bonding and joint strength between the substrate and the projection.

Whilst there has been described in the foregoing description exemplary embodiments of the present invention, it will be understood by those skilled in the technology concerned that many variations and combination in details of design, construction and/or operation may be made without departing from the present invention. For example, the shapes and dimensions of the substrates and projections that may be used and/or created in various embodiments of the presently disclosed method and fabricated interfacial structure are not limited to those described above with reference to the accompanying figures.

1. A method of fabricating an interfacial structure, the interfacial structure comprising a substrate and a projection on the substrate, the method comprising the steps of:
a) providing the substrate;
b) creating a number of steps on a surface of the substrate; and
c) fabricating the projection on the substrate by additive manufacturing onto the number of steps, thereby creating a stepped interfacial joint between the substrate and the projection.

2. The method of claim 1, wherein step b) comprises creating the number of steps as a recess on the surface of the substrate.

3. (canceled)

4. The method of claim 1, wherein step b) comprises creating the number of steps as a protrusion on the surface of the substrate.

5. (canceled)

6. The method of claim 1, wherein step b) comprises creating the number of steps by subtractive manufacturing.

7. The method of claim 6, wherein in step b), the number of steps are created by metal machining and wherein in step c), the projection is created by laser metal deposition.

8. The method of claim 1, wherein step a) comprises fabricating the substrate by additive manufacturing.

9. The method of claim 8, wherein step b) comprises creating the number of steps during additive manufacturing fabrication of the substrate.

10. The method of claim 1, wherein the stepped interfacial joint comprises a metallurgical bond.

11. The method of claim 1, wherein each of the number of steps comprises a sideways-facing surface and an upwards-facing surface when the surface of the substrate is facing up, wherein step a) comprises creating each sideways-facing surface to be at an angle □ from the vertical and creating each upwards-facing surface to be at an angle □ from the horizontal, and wherein □ and □ each ranges from 0° to 80°.

12. The method of claim 11 wherein step a) comprises creating a fillet between at least one upwards-facing surface and one sideways-facing surface.

13. The method of claim 11, wherein step a) comprises creating a chamfer between at least one sideways-facing surface and one upwards-facing surface.

14. The method of claim 1, wherein step b) comprises fabricating a thin-walled solid body of the projection onto the number of steps.

15. The method of claim 1, wherein step b) comprises fabricating a non-hollow portion of the projection onto the number of steps.

16. A fabricated interfacial structure comprising:
a substrate having a number of steps created on a surface of the substrate;
a projection fabricated by additive manufacturing onto the number of steps; and
a stepped interfacial joint between the substrate and the projection.

17. The fabricated interfacial structure of claim 16, wherein the number of steps are created as a recess on the surface of the substrate and the number of steps fully surround the recess.

18. (canceled)

19. The fabricated interfacial structure of claim 16, wherein the number of steps are created as a protrusion on the surface of the substrate and the number of steps fully surround the protrusion.

20. (canceled)

21. The fabricated interfacial structure of claim 16, wherein the stepped interfacial joint comprises a metallurgical bond.

22. The fabricated interfacial structure of claim 16, wherein each of the number of steps comprises a sideways-facing surface and an upwards-facing surface when the surface of the substrate is facing up, wherein each sideways-facing surface is at an angle □ from the vertical and each upwards-facing surface is at an angle □ from the horizontal, and wherein □ and □ each ranges from 0° to 80°.

23. The fabricated interfacial structure of claim 16, wherein the projection comprises a thin-walled solid body fabricated onto the number of steps.

24. The fabricated interfacial structure of claim 16, wherein the projection comprises a non-hollow solid body fabricated onto the number of steps.
